(19) United States
(12) Patent Application Publication
(10) Pub. No.: US 2012/0034832 A1
(43) Pub. Date: Feb. 9, 2012

(54) LAYERED ART MATERIAL WITH SILK

(76) Inventors: Evette Michelle Morgan, Kirribilli (AU); Diane Elizabeth Giusa, New South Wales (AU)

(21) Appl. No.: 13/147,569

(22) PCT Filed: Feb. 10, 2010
(86) PCT No.: PCT/AU10/00141

§ 371 Date: Oct. 18, 2011

(30) Foreign Application Priority Data
Feb. 10, 2009 (AU) 2009900527

(51) Int. Cl. B32B 7/04; D06P 1/00; B05D 5/00; B32B 7/12; B32B 27/34; D03D 9/00

(52) U.S. Cl. 442/1; 428/474.4; 428/221; 427/288; 156/327; 8/636

(57) ABSTRACT

A layered material including a working surface layer bonded to a material layer wherein the working surface layer is at least partially composed of silk.

### FIELD OF THE INVENTION

The present invention relates to a layered material and in particular a layered material that may be used as an artistic medium for painting and/or drawing.

### BACKGROUND OF THE INVENTION

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

In developing an artwork, an artist will draw upon numerous materials to achieve a desired visual effect. For painted works the choice of canvas is an important one, often limiting the range of paints (e.g. oil, acrylic, watercolour) that may be used. It is known that certain compositions of canvas are better suited to certain compositions of paints.

A variety of materials are available for use as canvases, providing different visual effects to the artist. Favourably used out of tradition and durability are those canvases composed of Cotton duck or Belgium linen. These traditional canvas materials work well for oil and acrylic paints, yet tend to suffer when it comes to the use of watercolours.

Watercolours are difficult to work with on traditional oil and acrylic canvases, particularly because they absorb poorly. Watercolours will often form damaging pools of paint at the canvas surface. The poor absorption also makes it difficult for the artist to move paint around the canvas without lifting what has already been painted.

Specialised canvases formed to receive watercolours have yet to become as durable as those available for oil and acrylic paints. Whilst partially addressing the absorption issues, these specialised canvases maintain some of the durability problems associated with painting on paper. One such example of these problems is the canvas becoming prone to damage when wet.

Alternative methods for canvas painting in watercolour have been to apply an intermediate binding layer to oil and acrylic canvases. However, these techniques have not been able to reach the desired watercolour retention performance.

There is clearly a need for a canvas that can mimic the effect achieved by watercolour paints on paper, whilst retaining the durability associated with traditional oil or acrylic canvases.

### SUMMARY OF THE PRESENT INVENTION

Thus, the present invention seeks to substantially overcome, or at least ameliorate, one or more disadvantages of existing arrangements.

It will be appreciated that the broad forms of the invention may be used individually or in combination.

According to one aspect the present invention provides a layered material including a working surface layer bonded to a material layer wherein the working surface layer is at least partially composed of silk.

According to one form, the working surface layer is substantially composed of silk and preferably composed entirely of silk.

In one form, the working surface layer is bonded to the material layer by means of an adhesive. The adhesive may be chosen from any suitable adhesive such as for example a natural adhesive, a synthetic adhesive, a drying adhesive, contact adhesive, reaction adhesive and/or thermoplastic adhesives. In a preferred form, the adhesive is a water based acrylic gel such as for example such as for example Ateliers Impasto Gel™ or Ateliers Impasto Paste Medium™.

According to one form, the material layer is composed of any suitable material that may be bonded to the working surface layer that provides sufficient structural support to the layered material once formed, such as for example a textile material or a paper material. In a preferred form, the material layer may be composed of any suitable textile material such as for example, cotton, polyester, hemp, nylon, silk and/or a mixture thereof. In a preferred form, the material layer is chosen from linen or cotton such as for example Belgian linen or cotton duck

In an alternative form, the material layer is chosen from a mesh material such as for example a polyester mesh or a silk mesh.

In one form, the material layer may be treated prior to forming the layered material with a primer. In a preferred form, the material layer may be treated with at least one coat of primer and in a more preferred form, the material layer may be treated with at least three coats of primer.

According to one form, the material layer has been treated with a primer. The primer may be chosen from any suitable primer composition including an acrylic gesso such as for example Atelier Artist Acrylic Gesso™.

According to a preferred form, the layered material is treated with any suitable binding medium, such as for example Atelier binding medium™. In this form, the binding medium may be directly applied to the working surface layer. Alternatively, the binding medium may be mixed with the adhesive, such as a water based acrylic gel, prior to bonding the working surface layer to the material layer. In this form, the ratio of binding medium to water based acrylic gel is between 1:5 and 3:5. In a preferred form, the ratio of binding medium to water based acrylic gel is 2:5.

According to a further aspect, the layered material of the present invention may be used as an artist's medium and in particular a medium to paint and/or draw upon. According to this form, the materials used to paint and/or draw upon may include: oil based paints, water based paints, charcoal, crayon, dyes, inks, chalk and pencil.

According to another aspect the present invention provides a method of forming a layered material including the steps of:
applying an adhesive to a material layer and/or a working surface layer at least partially composed of silk; and,
binding the working surface layer to the material layer.

### DETAILED DESCRIPTION OF THE INVENTION INCLUDING PREFERRED EMBODIMENTS

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

In accordance with the present invention there is provided a layered material that may be used as an artistic medium for painting and/or drawing. By using a working surface layer that is substantially composed of silk, the working surface of the layered material provides a medium that can hold artist materials such as water based paints, chalk, crayon, oil based paints, dyes, and/or charcoal in a significantly improved manner to that of commonly used canvases that are typically only used with oil based paints.

In accordance with one embodiment of the present invention the layered material is composed of a working surface layer that is substantially composed of silk and preferably entirely composed of silk that is bonded to a material layer. The material layer in effect provides structural support to the silk layer such that the layered material can be used in a similar manner to an artist's canvas.

The silk layer may be composed of any suitable type of silk. In a preferred form, the silk is a very thin silk with a fine weave such as Jap silk.

In a preferred embodiment the silk working surface layer is bonded to the material layer using an adhesive. The adhesive may be applied to either the material layer or the working surface layer or to both layers after which the working surface layer is applied to the surface of the material layer and the adhesive is allowed to dry and/or cure. In an alternative embodiment, the working surface layer may be dipped entirely into the adhesive after which the working surface layer is removed and then spread over the material layer and left to bond thereto. In a further alternatively, the adhesive is sprayed onto either the material layer, or the working surface layer or both.

The adhesive may be chosen from any suitable adhesive. In a preferred form, the adhesive is a water based acrylic gel such as for example Ateliers Impasto Gel™ or Ateliers Impasto Paste Medium™.

According to this embodiment a preferred material for use as the material layer is a substantially white or light coloured material that is already primed such as for example Belgian linen or cotton duck. If the material layer is not primed then in order to provide further strengthening properties, the material layer may be treated with a primer that if desired may also impart a substantially white colour, such as, for example, an Artist Acrylic Gesso. It is preferred that at least one primer layer is applied to the material layer. However, at least three primer layers is further preferred. In particular it is further preferred if each coat of primer is allowed to subsequently dry before applying the next coating.

In addition, a further binding medium may be used in addition to the adhesive in order to increase the bind between the silk working surface layer and artists materials such as oil based paints, water paints, pencils, crayons and the like. In one embodiment, the binding medium is mixed in with the adhesive prior to bonding the working surface layer to the material layer. In this form, any suitable binding medium may be used such as for example Atelier binding medium™.

In an alternative embodiment, the material layer may be composed of a mesh, such as, for example, a polyester and/or silk mesh. In order to provide further strengthening properties of the mesh material, the material layer may be treated with a primer that if desired, may also impart a substantially white colour, such as, for example, an Artist Acrylic Gesso. It is preferred that at least one primer layer is applied to the mesh. However, at least three primer layers is further preferred. In particular it is further preferred if each coat of primer is allowed to subsequently dry before applying the next coating.

In accordance with each of the embodiments outlined above, once the layered material is formed and properly dried, it may then be stretched over a frame to act like an artist's canvas that may be used with any type of material for drawing and/or painting purposes. In addition, the layered material may be used as a textile for any suitable use such as for fashion and clothing, home wares, such as lampshades, wallpaper and for a medium to print directly onto using various printing techniques.

According to a further embodiment and in seeking to produce the layered material, one begins with applying a water based acrylic gel to one surface of the material layer. Optionally and before applying the adhesive, or alternatively after, at least one coat of a primer such as acrylic gesso is applied to the other surface of the material layer evenly to strengthen the material layer. Preferably three coats are applied, each coat allowed to dry before application of the next. The inclusion of a primer coating is dependent on the nature of the first material layer and whether, for example, it has the desired strength and/or structural properties to support the working surface layer.

Silk is then layered to the other side of the first material layer. A water-based acrylic gel is applied with the silk, working it into the silk as the silk is set down. Preferably all air bubbles are removed by pressing down on the silk whilst working in the water based acrylic gel. Ateliers Impasto Gel may be used as the water based acrylic gel.

Alternatively, the water based acrylic gel may be sprayed onto the surface of the material layer. In this regard the water based acrylic gel may be introduced by means of a spray gun which provides an even coating over the material layer prior to the working surface layer being positioned on top.

In an optional step a binding medium such as Atelier binding medium™ may be mixed in with the water based acrylic gel in a ratio of about 5 parts water based acrylic gel to about 2 parts binding medium. The subsequent mixture is then sprayed onto the surface of the material layer.

Once the silk layer is then layered on top of the spray applied water based acrylic gel (with optional binding medium)

It is noted that when no strengthening layer is required, the binding composition is only applied to a first side of the material layer, and the silk with impasto gel subsequently layered to this same side. When using pre primed cotton duck or Belgian linen as the first material layer, a strengthening layer of primer may not be necessary.

Once the water based acrylic gel dries, the formed layered material provides advantages including, for example, its durability and ability to retain watercolour paints as well as other artist's materials effectively. The material is capable of being stretched over a wooden frame for use as an artist's medium.

The present invention will become better understood from the following example of a preferred but non-limiting embodiment thereof.

### EXAMPLE

A layer of cotton duck, linen or silk mesh is taken to form the material layer which is initially primed using Artist Acrylic Gesso wherein three coats of Artist Acrylic Gesso are applied to the material layer to provide a substantially white appearance. It is preferred that each coat of the Artist Acrylic Gesso is dried prior to applying the next coat.

A working layer composed of silk is then cut to size to fit over the material layer. Ateliers Impasto Gel™ is then mixed in with Atelier binding medium™ to form a composition with a ratio of Ateliers Impasto Gel™ to Atelier binding medium™ of 5:2. This composition is then placed into a spray gun and the mixture is sprayed onto the primed material layer in two coats with about 15 to 30 seconds of time between coats to allow the first coat to settle.

The working surface layer of silk is then placed on top of the two coats of composition before it is allowed to dry producing a layered material suitable for use as an artist medium.

1-18. (canceled)

19. A layered material comprising a working surface layer bonded to a material layer, wherein the working surface layer is at least partially composed of silk, and wherein the working surface layer is bonded to the material layer by means of a water based acrylic gel.

20. The layered material according to claim 19 wherein the working surface layer is composed of silk.

21. The layered material according to claim 19 wherein the water based acrylic gel is selected from the group consisting of Ateliers Impasto Gel™ and Ateliers Impasto Paste Medium™.

22. The layered material according to claim 19 wherein the material layer is composed of a material that provides sufficient structural support to the layered material once formed.

23. The layered material according to claim 19 wherein the material layer is one of a textile material or a paper material.

24. The layered material according to claim 19 wherein the material layer is composed of a textile material chosen from cotton, polyester, hemp, nylon, silk and/or a mixture thereof.

25. The layered material according to claim 24 wherein the material layer is chosen from linen or cotton.

26. The layered material according to claim 24 wherein the material layer is chosen from Belgian linen or cotton duck.

27. The layered material according to claim 19 wherein the material layer comprises a mesh material.

28. The layered material according to claim 19 wherein the material layer is treated by application of at least one coat of primer prior to forming the layered material.

29. The layered material according to claim 28 wherein the material layer is treated with at least three coats of primer.

30. The layered material according to claim 28 wherein the primer is an acrylic gesso.

31. The layered material according to claim 19 wherein the working surface layer is treated with a binding medium.

32. The layered material according to claim 19 wherein a binding medium is mixed with the adhesive.

33. A method of using a layered material comprising:
providing or receiving a layered material comprising a working surface layer bonded to a material layer, wherein the working surface layer is at least partially composed of silk, and wherein the working surface layer is bonded to the material layer by means of a water based acrylic gel; and
applying at least one marking medium onto the layered material.

34. The method of claim 33 wherein the marking medium includes at least one of an oil based paint, water based paint, charcoal, crayon, dye, ink, chalk or pencil.

35. The method of claim 33 wherein the layered material is an artists medium.

36. A method of forming a layered material comprising the steps of:
applying a water based acrylic gel to a material layer and/or a working surface layer at least partially composed of silk; and,
binding the working surface layer to the material layer.
